(19) United States
(12) Patent Application Publication
(10) Pub. No.: US 2014/0229122 A1
(43) Pub. Date: Aug. 14, 2014

(54) METHOD FOR PREDICTING FAULTS IN AN AIRCRAFT THRUST REVERSER SYSTEM

(71) Applicant: GE Aviation Systems Limited, Cheltenham (GB)

(72) Inventors: Robert William Horabin, Southampton (GB); Julia Ann Howard, Lee-On-The-Solent (GB); Daniel James Heath, Southampton (GB)

(73) Assignee: GE Aviation Systems Limited, Cheltenham (GB)

(21) Appl. No.: 14/152,241

(22) Filed: Jan. 10, 2014

(30) Foreign Application Priority Data
Feb. 12, 2013 (GB) 13024294

(51) Int. Cl. G01M 17/00

(52) U.S. Cl. CPC G01M 17/00
USPC 702/35

(57) ABSTRACT

A method for predicting faults in an aircraft thrust reverser system, the method includes receiving a position signal, determining a variation in the position signal relative to a reference position, predicting a fault in the thrust reverser based on the variation, and providing an indication of the predicted fault.

### CROSS-REFERENCE TO RELATED APPLICATIONS

This application claims priority under 35 U.S.C. §119 to British Patent Application No. 13024294, filed Feb. 12, 2013, the disclosure of which is incorporated herein by reference in its entirety.

### BACKGROUND OF THE INVENTION

Contemporary aircraft may include a thrust reverser system to assist in reducing the aircraft speed during landing. Typical thrust reversers include a movable element that when in the active position reverses at least a portion of the air flow passing through an engine of the aircraft. Faults in the thrust reverser system can cause problems during a flight, delays through unscheduled maintenance, and further operational impacts including loss of revenue.

### BRIEF DESCRIPTION OF THE INVENTION

In one embodiment, the invention relates to a method for predicting faults in an aircraft thrust reverser system, the method includes receiving a position signal from the position sensor, determining a variation in the position signal relative to reference position, predicting a fault in the thrust reverser based on the variation, and providing an indication of the predicted fault.

### BRIEF DESCRIPTION OF THE DRAWINGS

In the drawings:

FIG. 1 is a schematic view of a portion of an aircraft having an exemplary thrust reverser system;

FIG. 2 is a perspective view of the aircraft of FIG. 1 and a ground station in which embodiments of the invention may be implemented; and

FIG. 3 is a flowchart showing a method of predicting a thrust reverser fault in an aircraft according to an embodiment of the invention.

### DESCRIPTION OF EMBODIMENTS OF THE INVENTION

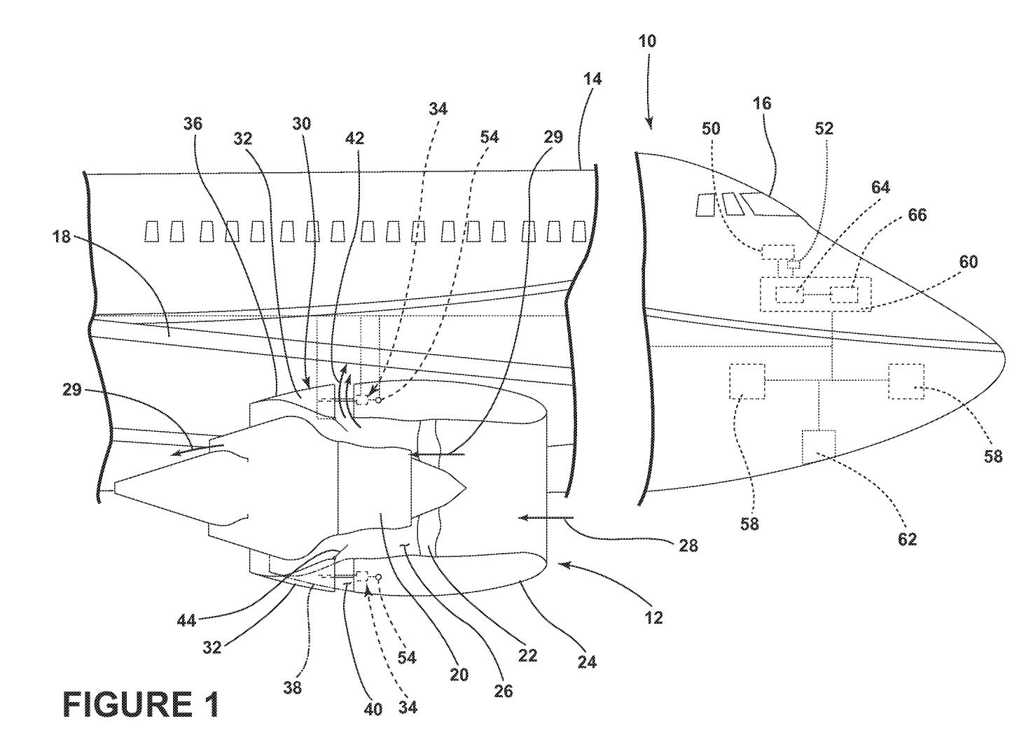

FIG. 1 schematically depicts a portion of an aircraft 10 that may execute embodiments of the invention and may include one or more engine assemblies 12 coupled to a fuselage 14, a cockpit 16 positioned in the fuselage 14, and wing assemblies 18 extending outward from the fuselage 14. A turbine engine 20, a fan assembly 22, and a nacelle 24 may form portions of each of the engine assemblies 12. Portions of the nacelle 24 have been cut away for clarity. The nacelle 24 surrounds the turbine engine 20 and defines an annular air flow path or annular bypass duct 26 through the engine assembly 12 to define a generally forward-to-aft bypass air flow path as schematically illustrated by the arrow 28. Combustion airflow is schematically illustrated by the arrows 29.

A thrust reverser system 30 includes at least one thrust reverser 32 having at least one actuator 34 for moving the at least one thrust reverser 32 between a deployed or reversing position 36 and a retracted or stowed position 38 (phantom). The thrust reverser 32 may thus include a moveable element attached to the engine assembly 12. Each of the engine assemblies 12 may include one or more thrust reversers 32. In the deployed position the thrust reverser 32 may be configured to reverse at least a portion of the bypass air flow. In the illustrated example, the moveable portion of the thrust reverser 32 is a cowl portion that is capable of axial motion with respect to the forward portion of the nacelle 24. While a single actuator 34 may be utilized, multiple actuators 34 have been illustrated as being operably coupled to the thrust reverser 32 to move the thrust reverser 32 into and out of the deployed position. Any suitable actuators 34 may be used including hydraulic actuators.

In the reversing position 36, the thrust reverser 32 limits the annular bypass area between the thrust reverser 32 and the turbine engine 20, it also opens up a portion 40 between the thrust reverser 32 and the forward portion of the nacelle 24 such that the air flow path may be reversed as illustrated by the arrows 42. An optional deflector or flap 44 may be included to aid in directing the air flow path between the thrust reverser 32 and the forward portion of the nacelle 24. There are several methods of obtaining reverse thrust on engine assemblies including using sleeves and buckets. The specific design of the at least one thrust reverser 32 is not germane to embodiments of the invention and will not be described further herein.

A throttle lever 50, schematically illustrated, may be included in the cockpit 16 and may be operated by a pilot to set the position of the thrust reversers 32. The term throttle lever as used in this description is not limited to a physical lever, rather it relates to the control device used to set the position of the thrust reversers 32. Throughout the early part of aviation, this control device was a lever and the term throttle lever has now become generic to the control device used to set the thrust reverser, regardless of whether the control device is an actual lever or a button on a touch-screen user interface. The throttle lever 50 may provide an input to the actuators 34 to move the thrust reverser 32. A throttle lever sensor 52 or other suitable mechanism may be used for determining the position of the throttle lever 50. It is contemplated that the throttle lever may have two independently moving halves to control thrust reversers 32 on corresponding sides of the aircraft 10 or that the aircraft 10 may have one independently moving throttle lever 50 for each engine assembly 12. In such an instance, multiple throttle lever sensors 52 may be utilized.

One or more position sensors 54 may be included in the thrust reverser system 30 and each may output a position signal indicative of the position of the actuator 34 to which each is operably coupled. As the actuators 34 used to drive a particular thrust reverser 32 are mechanically synchronized, it is contemplated that only one position sensor 54 needs to be utilized for each thrust reverser 32. It will also be noted that a single thrust reverser may include multiple moveable components and that each may include a position sensor 54 on one of their actuators 32. Further, multiple position sensors 54 may be utilized for redundancy purposes. The position sensor 54 may output a position signal indicative of the degree of extension of the actuator 34. The degree of extension may be between the positions corresponding to the deployed position and stowed positions of the thrust reverser 32. The degree of extension may be relative to a reference position and the position signal may be indicative of the relative degree of extensions. For example, the degree of extensions may be relative to the last position of the actuator even though the last position of the actuator did not correspond to the deployed position of the thrust reverser 32 or the stowed positions of the thrust reverser 32. The position sensor 54 may output absolute position signals and/or referential position signals. Further, the position sensor 54 may also output binary flags as to whether the thrust reverser(s) 32 are fully stowed, fully deployed etc., and these may also be utilized.

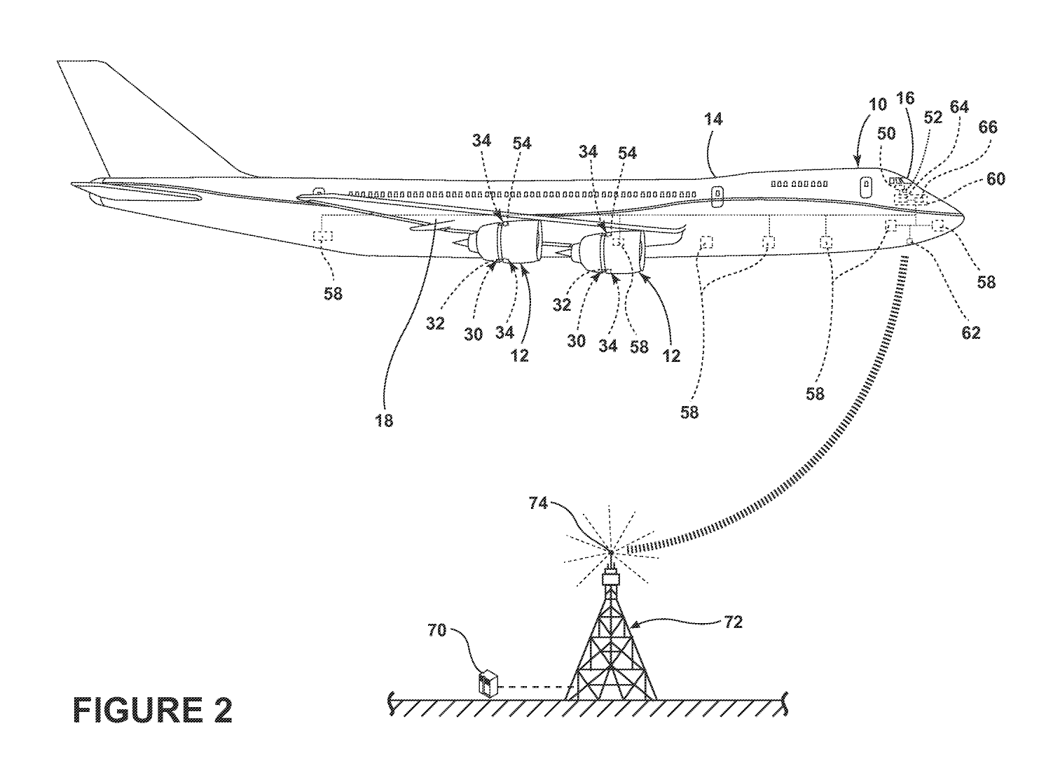

Referring now to FIG. 2, for illustrative purposes, the aircraft 10 has been illustrated as including four engine assemblies 12; however, it will be understood that a different number of engine assemblies 12 may be included. A plurality of additional aircraft systems 58 that enable proper operation of the aircraft 10 may also be included in the aircraft 10 as well as a controller 60, and a communication system having a wireless communication link 62. The controller 60 may be operably coupled to the plurality of aircraft systems 58 including the thrust reverser system 30. For example, the throttle lever 50, the throttle lever sensor(s) 52, the actuators 34, and the one or more position sensors 54 may be operably coupled to the controller 60.

The controller 60 may also be connected with other controllers of the aircraft 10. The controller 60 may include memory 64, the memory 64 may include random access memory (RAM), read-only memory (ROM), flash memory, or one or more different types of portable electronic memory, such as discs, DVDs, CD-ROMs, etc., or any suitable combination of these types of memory. The controller 60 may include one or more processors 66, which may be running any suitable programs. The controller 60 may be a portion of an FMS or may be operably coupled to the FMS.

A computer searchable database of information may be stored in the memory 64 and accessible by processor 66. The processor 66 may run a set of executable instructions to access the database. Alternatively, the controller 60 may be operably coupled to a database of information. For example, such a database may be stored on an alternative computer or controller. It will be understood that the database may be any suitable database, including a single database having multiple sets of data, multiple discrete databases linked together, or even a simple table of data. It is contemplated that the database may incorporate a number of databases or that the database may actually be a number of separate databases.

The database may store data that may include historical data related to the thrust reversers 32 for the aircraft 10 including previous timing for movement of the thrust reversers 32. The database may also include reference values including predetermined reference position values for the thrust reverser 32 including when the thrust reverser 32 is considered to be stowed, stowing, deployed, deploying, and when it is at a minimum position for successful deployment. For example, the thrust reverser 32 may be considered stowed when the actuator position is less than two percent of the anticipated range of motion, the thrust reverser 32 may be considered stowing when the actuator position is from less than two percent of a maximum deployed position towards two percent, the thrust reverser 32 may be considered deployed when the actuator position is less than two percent less than a maximum deployed position during the current event, the thrust reverser 32 may be considered deploying when the actuator position is moving from two percent towards , and the minimum position for successful deployment may be greater than ninety percent of the anticipated range of motion. If during operation the thrust reverser 32 begins to move in a more limited range of motion, it is contemplated that these percentages may be utilized with respect to the new range of motion. The database may also include reference values including predetermined reference position values for the throttle lever 50 including when the throttle lever 50 is considered to be in a forward thrust position or reverse idle position where the thrust reverser sleeves should not be deployed. For example, the forward thrust value may include the throttle lever being at greater than 35 degrees and the reverse idle may include the throttle lever being between 35-30 degrees after being greater than 35 degrees. Further, the database may also include reference values including predetermined reference position values for when the throttle lever 50 is considered to be in a reverse thrust position or a reverse idle position where the thrust reverser sleeves should be deployed. For example, the reverse thrust value may include the throttle lever being at less than 30 degrees and the reverse idle may include the throttle lever being between 30-34 degrees after being less than 30 degrees.

Alternatively, it is contemplated that the database may be separate from the controller 60 but may be in communication with the controller 60 such that it may be accessed by the controller 60. For example, it is contemplated that the database may be contained on a portable memory device and in such a case, the aircraft 10 may include a port for receiving the portable memory device and such a port would be in electronic communication with the controller 60 such that controller 60 may be able to read the contents of the portable memory device. It is also contemplated that the database may be updated through the wireless communication link 62. Further, it is contemplated that such a database may be located off the aircraft 10 at a location such as airline operation center, flight operations department control, or another location. The controller 60 may be operably coupled to a wireless network over which the database information may be provided to the controller 60.

While a commercial aircraft has been illustrated, it is contemplated that portions of the embodiments of the invention may be implemented anywhere including in a computer 70 at a ground system 72. Furthermore, database(s) as described above may also be located in a destination server or computer 70, which may be located at and include the designated ground system 72. Alternatively, the database may be located at an alternative ground location. The ground system 72 may communicate with other devices including the controller 60 and databases located remote from the computer 70 via a wireless communication link 74. The ground system 72 may be any type of communicating ground system 72 such as an airline control or flight operations department.

One of the controller 60 and the computer 70 may include all or a portion of a computer program having an executable instruction set for predicting a thrust reverser fault in the aircraft 10. Such a fault may include improper operation of a component in the thrust reverser system 30 as well as failure of a component in the thrust reverser system 30. Regardless of whether the controller 60 or the computer 70 runs the program for predicting the fault, the program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implement particular abstract data types. Machine-executable instructions, associated data structures, and programs represent examples of program code for executing the exchange of information as disclosed herein. Machine-executable instructions may include, for example, instructions and data, which cause a general purpose computer, special purpose computer, or special purpose processing machine to perform a certain function or group of functions.

It will be understood that the aircraft 10 and the computer 70 merely represent two exemplary embodiments that may be configured to implement embodiments or portions of embodiments of the invention. During operation, either the aircraft 10 and/or the computer 70 may predict a thrust reverser fault.

By way of non-limiting example, while the aircraft 10 is being operated the throttle lever 50 may be utilized to set the position of the thrust reversers 32. The throttle lever sensor 52 may output a signal indicative of the position of the throttle lever 50 and the one or more position sensors 54 may output position signals indicative of the position of the actuators 34 and thus the position of the thrust reversers 32. The one or more actuators 34 are themselves commanded to begin motion by the pilot entering reverse with the throttle lever 50.

The controller 60 and/or the computer 70 may utilize inputs from the throttle lever sensor 52, the position sensors 54, the database(s) and/or information from airline control or flight operations department to predict the thrust reverser fault. Among other things, the controller 60 and/or the computer 70 may analyze the data output by the throttle level sensor 52 and the position sensors 54 to predict faults in the thrust reverser system 30. For example, it has been determined that by determining the time lag between the pilot entering or leaving reverse thrust and when or if the actuators 34 begin motion, as well as the time lag between actuators 34 beginning and completing motion, faults may be predicted including the failure to deploy, slow to deploy, failure to stow, slow to stow, etc. It has also be determined that faults may be predicted based on whether the thrust reversers 32 are slow to stow or deploy. The more serious faults including failures are often alluded to by the slow to stow and slow to deploy determinations, giving the ability to predict when such serious failures are likely to occur. In this manner, the controller 60 and/or the computer 70 may predict faults in the thrust reverser system 30. Once a thrust reverser fault has been predicted an indication may be provided on the aircraft 10 and/or at the ground system 72. It is contemplated that the prediction of the thrust reverser fault may be done during flight, may be done post flight, or may be done at the end of the day after any number of flights or may be done after any time period and number of flights or deployments of the thrust reversers. The wireless communication link 62 and the wireless communication link 74 may both be utilized to transmit data such that the fault may be predicted by either the controller 60 and/or the computer 70.

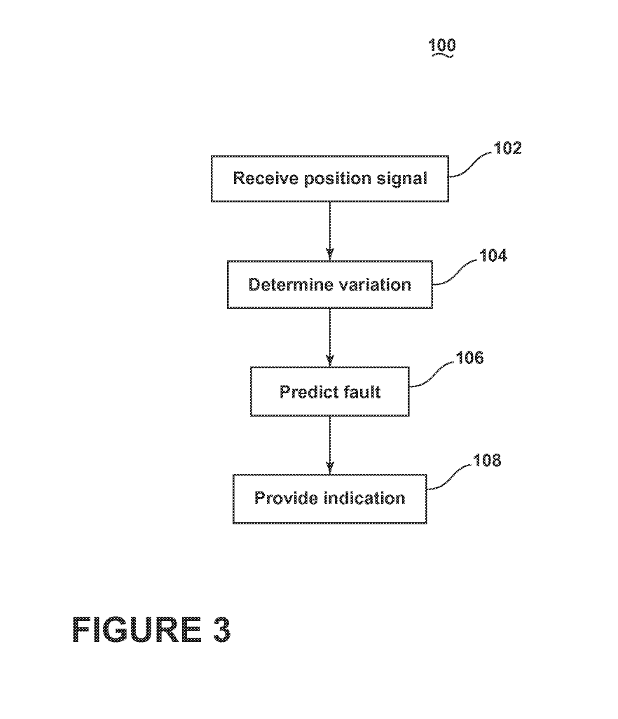

In accordance with an embodiment of the invention, FIG. 3 illustrates a method 100, which may be used for predicting a thrust reverser fault. The method 100 begins at 102 by receiving a position signal from a position sensor, which is indicative of a position of at least one of the thrust reversers 32. This may include receiving a position signal from one of the position sensors 54 regarding the degree of extensions of the one or more actuators 34. The degree of extension of the one or more actuators 34 is indicative of the position of the thrust reverser 32 that the actuators 34 are operably coupled to. More specifically, each actuator 34 gives a percentage of deployment of the thrust reverser's anticipated range of motion. It will be understood that in the case where the thrust reverser 32 includes multiple moveable components that the position signal may be indicative of a position of one of the multiple components. In this manner, multiple position signals may be received for a single thrust reverser 32 with each of the multiple position signals being indicative of the movement of one of the moveable components.

At 104, a variation in the position signal relative to a reference position may be determined. The reference position may include any number of reference positions related to the thrust reverser system 30. The reference position may include a value related to a position of any of the thrust reversers 32 including, a set position for the thrust reverser 32 or another received position signal. For example, the set position may correspond to at least one of a deployed position of the thrust reverser and a retracted position of the thrust reverser. The set position may also be a point within a threshold near each of these positions. Furthermore, the reference position may include a value related to historical information regarding the position of the thrust reversers 32. Furthermore, the reference position value may be indicative of a position of the throttle lever 50. In such an instance, the method may include determining a position of the throttle lever 50 such as by receiving an output from the throttle lever sensor 52 to define the reference position value. Any suitable value may be used as a reference position value and the reference position values may be stored in one of the database(s) as described above.

Any suitable variation may be determined to aid in predicting the fault in the thrust reverser system 30. For example, determining a variation may include comparing the position signal to the reference position. Determining a variation may alternatively include determining from the position signal a time for the actuator 34 and/or the thrust reverser 32 to move to the reference position. For example, it may be determined how long it takes the thrust reverser 32 to deploy or stow. Determining a variation may also include determining from the position signal a time for the actuator 34 and/or the thrust reverser 32 to begin movement to the reference position. It is also contemplated that determining the variation may include comparing the position signal to multiple reference positions including the signals from parts of the throttle lever 50. Determining the variation may further include determining from the position signal a time for the actuator 34 and/or the thrust reverser 32 to move between the multiple reference positions.

It is contemplated that the variation may account for tolerances for the various components being compared including the tolerance for the sensors being used. For example, if the position comparison includes comparing a position signal of one of the actuators 34 to a reference value then the variation reference value may be defined by tolerances for the actuator 34 and/or the position sensor 54. Alternatively, if the controller 60 and/or the computer 70 is tracking the variation over time of the movement of the actuator, then the variation may be related to an acceptable change in the variation over time. Further still, if the position signal being compared is one of a maximum thrust reverser position over time or a minimum thrust reverser position over time. Then the variation reference value may be related to an acceptable change to determine if the thrust reverser is slowly limiting its movement over time. Further still, the variation may account for a known frequency of data determination of the various sensors.

At 106, a fault in the thrust reverser system may be predicted based on the variation. For example, a fault in the thrust reverser system 30 may be predicted when the variation has been determined to satisfy a predetermined threshold value. In this manner, the controller 60 and/or the computer 70 may determine if the variation is acceptable. The term “satisfies” the threshold is used herein to mean that the variation satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted.

By way of additional example, when the variation is determined from a time for the actuator to move to the reference position, a fault may be predicted by comparing the determined time to a reference time. More specifically, when the determined time is greater than the reference time a fault may be predicted. It is contemplated that the reference time may be a historical time value for the aircraft 10 and that in this manner the comparison may determine a difference in the movement of the thrust reverser 32 over time.

By way of non-limiting examples, the controller 60 and/or the computer 70 may record multiple slow-type events including slow to stow, slow to deploy, slow to end deployment, a failure to end stow, and a slow to end stow that have occurred within the last ten thrust reverser deployment events. The severity of slow-type events may then be determined and faults may be predicted therefrom. For example, any single slow-type event taking more than eight seconds may be considered high-severity, while taking less time gets a low-severity alert. If there have been four or more slow-type events of one type within the most recent ten events, or the average timing of one type is eight seconds or more, a high severity fault may be determined. If the average is below eight seconds and less than four events of the same type occur within the most recent ten events, a low severity fault may be determined.

In implementation, the reference values and comparisons may be converted to an algorithm to predict faults in the thrust reverser system 30. Such an algorithm may be converted to a computer program comprising a set of executable instructions, which may be executed by the controller 60 and/or the computer 70. Before predicting faults based on anomalous data it is contemplated that the computer program may check that the deployment events were sensible. This may be done by the computer program ensuring that the throttle lever 50 was in reverse idle or lower for at least three seconds, and that for stowing-related faults the pilot did not re-enter reverse idle within five seconds of leaving it.

Some of the most common faults that may be predicted by embodiments of the invention are failure to deploy, when the actuators 34 never complete deployment once the pilot has entered reverse throttle, slow to end deployment when the actuators 34 take unusually long to reach full deployment, failure to stow when the actuators 34 never fully stow once the pilot has left reverse throttle and slow to end stow when the actuators 34 take unusually long to reach fully stowed positions. By way of non-limiting examples, failure to deploy may be determined when the thrust reverser 32 failed to exceed two percent deployment of its anticipated range after the throttle lever 50 went from greater than 30 degrees to less than 30 degrees. Slow to deploy may indicate that there was an unusually long delay between the command to deploy and the beginning of movement by the thrust reverser 32. For example, this may be determined when the thrust reverser 32 exceeded two percent deployment in an excessive time, such as more than three seconds, after the throttle lever 50 went from greater than 30 degrees to less than 30 degrees. Failure to stow may include where the throttle lever 50 went from less than 34 degrees to greater than 34 degrees and any of the thrust reversers 32 failed to reach two percent less than their maximum deployment during the current event. Slow to stow may indicate that there was an unusually long delay between the command to stow and the beginning of movement by the thrust reverser 32. For example, this may be determined when a thrust reverser 32 reaches two percent less than its maximum deployment in an excessive time, such as more than three seconds, after the throttle lever 50 went from less than 34 degrees to greater than 34 degrees.

Additional faults such as a failure to end deployment, a slow to end deployment, a failure to end stow, and a slow to end stow may also be predicted. Failure to end deployment may be determined when the thrust reverser 32 exceeds two percent deployment but fails to achieve ninety percent deployment. Slow to end deployment may include when it takes an excessive time, such as more than three seconds for the thrust reverser 32 to go from two percent deployed to two percent less than its maximum value during the current deployment. Failure to end stow may be determined when the thrust reverser 32 reaches two percent less than its maximum deployment but fails to reach two percent deployment of its anticipated range. Slow to end stow may be determined when the thrust reverser 32 reaches two percent deployment after reaching two percent less than its maximum deployment in an excessive time, such as more than four seconds.

A specific example may prove useful. The computer program may determine the time between the throttle command and the beginning movement of the thrust reverser. The computer program may take a time difference between when the throttle lever 50 is indicated to have reached less than 30 degrees and when the thrust reverser 32 reaches greater than two percent deployed. The computer program may also take a time difference between when the thrust reverser 32 reaches greater than two percent deployed and when the thrust reverser 32 position goes to two percent less than its range of motion/highest deployment position during this data window. Provided the actuator 34 starts movement, it is considered a successful deployment if it subsequently reaches greater than 90 percent of its range of deployment. It is only considered as reaching full deployment when it reaches two percent less than the maximum deployment position during that event. For example, as long as the thrust reverser 32 is greater than the 90 percent the measurement will be taken but for instance if it eventually reaches 100 percent during deployment the computer program would only record when it has reached 98 percent. The recording is taken as a time difference from beginning movement to when it has reached the 98 percent. From the second the throttle lever 50 is less than 35 degrees, the thrust reverser 32 has 20 seconds to complete deployment.

There is a similar sequence of readings for the stowing procedure of thrust reversers. The computer takes a zero time when the throttle lever 50 goes from less than 34 degrees to greater than 34 degrees, which may be defined as leaving reverse idle. A time difference is determined between leaving reverse idle for each engine and each relevant thrust reverser 32 beginning movement such as going below two percent under the maximum deployment position during thrust reverser event and a time difference between beginning and completing movement. Again, the thrust reverser 32 has 20 seconds to complete stowing.

For example, if the movement of the thrust reverser takes one to three seconds longer than a reference value this may be considered a normal variation. Slows may be determined if the movement of the thrust reverser takes more than three seconds longer than a reference value. A failure may be determined if the movement takes more than ten seconds longer than the reference value, or reaching the reference value is not achieved.

At 108, the controller 60 and/or the computer 70 may provide an indication of the fault in the thrust reverser system 30 predicted at 106. An indication may be provided separately for each thrust reverser 32, moveable component of each thrust reverser 32, and each actuator 34. The indication may be provided in any suitable manner at any suitable location including in the cockpit 16 and at the ground station 72. For example, if the controller 60 ran the program, then the suitable indication may be provided on the aircraft 10 and/or may be uploaded to the ground system 72. Alternatively, if the computer 70 ran the program, then the indication may be uploaded or otherwise relayed to the aircraft 10. Alternatively, the indication may be relayed such that it may be provided at another location such as such as an airline control or flight operations department.

It will be understood that the method of predicting a thrust reverser fault is flexible and the method illustrated is merely for illustrative purposes. For example, the sequence of steps depicted is for illustrative purposes only, and is not meant to limit the method 100 in any way as it is understood that the steps may proceed in a different logical order or additional or intervening steps may be included without detracting from embodiments of the invention. By way of non-limiting example, the method may also include determining an actuation of the thrust reverser 32 during operation of the aircraft 10 and receiving the position signal before and after the determined actuation. In this manner, the position signal may only be received during a window around the actual thrust reverser event. For example, the window may be defined as 25 seconds pre and post when the throttle lever 50 is below 35 degrees and above one degree. The throttle levers 50 being between 35 and 30 degrees is considered “reverse idle”, i.e. the thrust reversers 32 will not begin deployment until the throttle levers 50 are less than 30 degrees. Thus, the throttle lever 50 may be considered to have entered reverse as it moves from greater than 30 degrees to less than 30 degrees. The time at which each of the throttle lever 50 does this is considered the zero time for timing movements of the actuators 34 for deployment events.

Technical effects of the above described embodiments include that data gathered by the aircraft during flight may be utilized to detect when the thrust reversers are working sub-optimally and to predict a thrust reverser fault. Currently, the recording of fault occurrences is discretionary and requires the fault to be entered manually into a database; this is costly and may not obtain all the relevant information. Further, there is currently no manner to predict the fault of a thrust reverser. The above described embodiments may result in many benefits including improved flight performance, which can have a positive impact on both operating costs and safety. The above embodiments allow accurate predictions to be made regarding the thrust reverser system faults. By predicting such problems sufficient time may be allowed to make repairs before such faults occur. This allows for cost savings by reducing maintenance cost, rescheduling cost, and minimizing operational impacts including minimizing the time aircraft are grounded. Further, by automating the recording of such faults, human error is reduced and a given aircraft's history will be more accurate, which may be helpful in future maintenance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for predicting faults in an aircraft thrust reverser system having at least one thrust reverser having at least one actuator for moving the thrust reverser between a deployed position and a retracted position, and a position sensor for outputting a position signal providing position data indicative of the position of the thrust reverser, the method comprising:
receiving a position signal from the position sensor;
determining a variation in the position signal relative to a reference position;
predicting a fault in the thrust reverser system based on the variation; and
providing an indication of the predicted fault.

2. The method of claim 1 wherein the determining the variation comprises comparing the position signal to the reference position.

3. The method of claim 2 wherein the reference position is a set position.

4. The method of claim 3 wherein the set position corresponds to at least one of a deployed position of the thrust reverser and a retracted position of the thrust reverser.

5. The method of claim 1 wherein the determining the variation comprises determining from the position signal a time for the actuator to move to the reference position.

6. The method of claim 5 wherein the predicting the fault comprises comparing the determined time to a reference time.

7. The method of claim 6 wherein the predicting the fault comprises determining the determined time is greater than the reference time based on the comparison.

8. The method of claim 7 wherein the reference time is a historical time value.

9. The method of claim 1 wherein the determining the variation comprises determining from the position signal a time for the actuator to begin movement to the reference position.

10. The method of claim 1 wherein determining the variation in the position signal is relative to multiple reference positions.

11. The method of claim 10 wherein the determining the variation further comprises determining from the position signal a time for the actuator to move between the multiple reference positions.

12. The method of claim 11 wherein the predicting the fault comprises comparing the determined time to a reference time.

13. The method of claim 1 wherein the reference position includes another received position signal.

14. The method of claim 1, further comprising determining an actuation of the thrust reverser during operation of the aircraft.

15. The method of claim 14 wherein the receiving the position signal includes receiving the position signal before and after the determined actuation.

16. The method of claim 1 wherein the predicted fault is at least one of a failure to deploy, a failure to stow, a slow to deploy, and a slow to stow.

17. The method of claim 1 wherein the predicted fault is at least one of a failure to end deployment, a slow to end deployment, a failure to end stow, and a slow to end stow.

18. The method of claim 1 wherein the position signal is a binary indication of the thrust reverser in at least one of a deployed position and a stowed position.
